(19) United States
(12) Patent Application Publication
(10) Pub. No.: US 2026/0317234 A1
(43) Pub. Date: Oct. 15, 2026

(54) FIRE-RESISTANT AND RECYCLABLE COMPONENT

(71) Applicant: STROHLOS PRODUKTENTWICKLUNG, Waren (DE)

(72) Inventor: Christian Losehand, Waren (DE)

(73) Assignee: Carmen Schwidrowitz, Waren (DE)

(21) Appl. No.: 19/483,627

(22) PCT Filed: May 13, 2024
(86) PCT No.: PCT/EP2024/063074

§ 371 Date: Nov. 12, 2025

(30) Foreign Application Priority Data
May 12, 2023 (DE) 102023112615.6

(51) Int. Cl. C04B 18/167; C04B 9/02; C04B 28/10; C04B 111/28

(52) U.S. Cl. CPC C04B 18/167; C04B 9/02; C04B 28/105; C04B 2111/28

(57) ABSTRACT

The invention relates to a method for producing fire-resistant and circular-economy-compatible building elements from renewable raw materials, a binder, and water, as well as a building element produced according to said method.

The object of the invention is to eliminate the disadvantages of the prior art and to provide a method for producing fire-resistant building elements from renewable raw materials, as well as a resulting building element, wherein the building element is water-resistant, diffusion-open, flame-retardant, and free from environmentally harmful additives.

This object is achieved by the features set forth in the claims.

The invention relates to a method for producing fire-resistant and circular-economy-compatible building elements from renewable raw materials, a binder, and water, as well as to a building element produced according to said method.

Building elements within the meaning of this invention can take various forms. The most probable form will be that of a panel. For example, a panel-shaped building element can be used for drywall construction in interior finishing. A panel-shaped building element can also serve as an acoustic and/or thermal insulation wall. A panel-shaped building element may likewise serve as a furniture panel, such as a tabletop. Such a panel-shaped building element may also be used to manufacture complex structures, such as furniture. It is also conceivable to produce complex functional structures from one or more building elements, for example, fire-resistant cable ducts. In addition, a building element according to this invention may also have a cuboid shape and be used like a brick. Other forms are not excluded. In principle, further processing and/or finishing of a building element, for example, painting, coating, laminating, etc., are not excluded.

Due to the growing world population and the necessity of achieving ambitious climate goals to limit global warming, there is a great demand in the construction sector for building elements based on rapidly renewable raw materials, especially since building elements according to the prior art lack or only inadequately exhibit circular-economy capability.

Natural building materials have numerous advantages, such as high thermal and acoustic insulation capacity, renewable resource origin, recyclability, or easy disposal through composting at a reasonable price, even for small production series.

Nevertheless, they must meet requirements for mechanical properties, particularly regarding strength and fire resistance, while maintaining low weight.

In general, such building elements are made from wood fibers or wood chips, glass fiber, or gypsum using a binder. Preferably, the materials are processed into panels. However, a disadvantage is that especially glass fibers and gypsum have high melting temperatures, requiring complex solutions both during production and recycling.

Recent efforts within the framework of a bio-based circular economy aim to utilize agricultural and industrial/civil waste materials for the above purpose, for example, the use of cereal, rapeseed, or hemp straw.

In this regard, EP 3 325 425 B1 discloses a building product in the form of an interior cladding panel and a method for producing the same. According to claim 6, the building product comprises up to 35 percent cement binder. The disadvantage of this is that cement-based binders impede the diffusion openness of the product, thereby promoting condensation and associated issues such as mold formation. Furthermore, the building product contains only up to 30 percent hemp shives, so that the majority of the interior panel consists of lime and cement binder, and the sustainable aspect plays only a peripheral role.

The same applies to the building product disclosed in WO2022157466A1. This describes a bio-based building product comprising a lignocellulose-containing plant granulate and a binder derived from calcium carbonate, as well as a process for producing the building product. Furthermore, according to claims 18 and 23, the product optionally contains a cement-type binder, which is disadvantageous.

There is therefore a need for a method that enables the production of a bio-based building element meeting the requirements of the construction industry, both in terms of mechanical properties and processability, as well as regarding ecological aspects, namely, the use of renewable raw materials, preferably from residual material streams of agricultural, forestry, and fisheries production, and environmentally friendly recyclability at the end of their service life.

### SUMMARY OF THE INVENTION

The object of the invention is to eliminate the disadvantages of the prior art and to provide a method for producing fire-resistant and circular-economy-compatible building elements from renewable raw materials, as well as a resulting building element, wherein the building element is water-resistant, diffusion-open, flame-retardant, and free from environmentally harmful additives.

This object is achieved by the features set forth in the claims.

The object is achieved by a method for producing fire-resistant building elements from rapidly renewable raw materials and/or recovered residual materials and/or circular-economy-compatible biopolymers, a binder, and water, wherein the rapidly renewable raw materials are at least one selected from the group consisting of cereal, rapeseed, flax, hemp, or rice straw, or algae, hops, maize, or paludiculture plants. Comparable renewable raw materials include, for example, hops, maize, and paludiculture species such as reed, cattail (Typha), sedges, or reed canary grass. The use of additional renewable raw materials is conceivable. The raw materials can be processed in their entirety, but are preferably shredded, for example, chopped.

The binder is a mixture of magnesium carbonate, magnesium oxide, and magnesium chloride.

The method comprises ten process steps:
(i) Introducing the binder and water into a temperature-controllable
(ii) Tempering the binder-water mixture within a first defined temperature range;
(iii) Mixing the binder-water mixture while maintaining the first defined temperature range;
(iv) Maintaining the first defined temperature range for a first defined period;
(v) Tempering the binder-water mixture within a second defined temperature range;
(vi) Adding the renewable raw materials while maintaining the second defined temperature range;
(vii) Mixing the binder-water-raw material mixture while maintaining the second defined temperature range;
(viii) Maintaining the second defined temperature range for a second defined period;
(ix) Discharging the binder-water-raw material mixture into a dimensionally stable mold; and
(x) Cooling and curing the binder-water-raw material mixture.

The composition of the mixtures, with respect to the proportions of raw material, magnesium carbonate, magnesium oxide, magnesium chloride, and water, can vary according to the desired properties of the target product for its intended application. For example, an increased raw material content can improve acoustic insulation for soundproofing. A higher binder content can increase fire resistance.

The adjustment of process parameters, temperature and holding time, can also vary. In general, the adjustment of these parameters serves to create the conditions for optimal mixing of binder and raw material. The heating increases the viscosity of the binder and enables a homogeneous coating of the raw material, which is a prerequisite for uniform curing during cooling. It also facilitates a latent decomposition of the raw material, increases its porosity, and thus enlarges its surface area for binder adhesion.

The setting of process parameters depends, among other things, on the type of raw material used. For example, parameters may differ when using cereal straw compared with algae, although they may also coincide. The simultaneous use of two or more raw materials is possible. Furthermore, process parameters may vary depending on the original habitat of the raw materials, as this significantly determines their composition. For instance, plants of the same species but different origins may have different lignocellulose contents. The parameters may also depend on the age of the raw materials, since this affects their composition. Additionally, storage duration and conditions may influence the process parameters. For example, it may be necessary to heat a raw material stored at 6 degrees Celsius longer than one stored at room temperature. A high raw material content may require longer mixing times to ensure adequate blending with the binder.

Cooling and curing of the binder-water-raw material mixture take place in air but can be accelerated by applying heat, for which the use of waste heat is conceivable.

In various embodiments, the method is continuous. Continuous implementation can, for example, be achieved by performing process steps (i) to (viii) in at least one appropriately dimensioned feed container that supplies a downstream production line. This may include a continuous pressing system according to the state of the art, as used in the continuous production of particleboard, OSB, MDF, and LVL under precise pressure and temperature conditions.

In various embodiments, the rapidly renewable agricultural raw materials are replaced entirely or partially by crushed and/or fractionated building elements produced according to claim 1.

For example, a building element, such as a furniture panel after one use cycle or a construction panel after one building cycle, can be shredded and separated into corresponding fractions, which can then be used in whole or as a mixture for new products.

Furthermore, biopolymers with inherent circular-economy compatibility, such as polyhydroxyalkanoates, can be used to produce the building elements.

It is also conceivable to use recovered residual materials, preferably from natural substances such as glass or circular-economy compatible materials, for example, civilian waste in the form of old packaging.

The goal is a complete reuse of the building elements and/or objects produced from them after reaching the end of their service life.

In various embodiments, process steps (i) to (x) are repeated using different mixture compositions and/or process parameters so that the resulting building element has two or more layers of different types.

Accordingly, a first binder-water-raw material mixture is coated with another, different binder-water-raw material mixture and cured together. It is also conceivable to cure the mixtures sequentially. For instance, a building element may be produced with a fire-resistant first side and an insulating second side. In this manner, building elements with three or more layers can also be produced.

In various embodiments, the process steps of tempering, mixing, and holding are computer-controlled and automated. This enables defined scenarios to run through specific processes automatically without manual intervention.

In various embodiments, the first defined temperature range lies between 25 and 60 degrees Celsius. The second defined temperature range may be identical or may differ.

In various embodiments, the defined periods last only a few seconds.

The invention also relates to a building element produced according to the described method, wherein the building element comprises at least one renewable raw material selected from the group consisting of cereal, rapeseed, flax, hemp, or rice straw, or algae, hops, maize, or paludiculture plants, and a binder consisting of magnesium carbonate, magnesium oxide, and magnesium chloride, as well as water, wherein the building element is water-resistant, diffusion-open, flame-retardant, and free from environmentally harmful additives.

In various embodiments, the raw material content of the building element is between 55 and 80 percent.

Preferably, the building element is a panel. Examples of fire-resistant panels include ceiling, floor, or wall panels for sound or heat insulation; decorative wall panels; tabletop surfaces; roofing materials; insulation boards or ducts for supply lines; soundproof coverings; backing panels for veneers; door materials; substrates in construction; as well as elements for furniture making, aircraft construction, vehicle manufacturing, or shipbuilding. Other applications are conceivable.

Common finishing and surface treatment methods can also be applied without restriction, for example, painting, coating, laminating, and others.

The building element produced by the described method exhibits high strength, is both bend-and tear-resistant, diffusion-open, flame-retardant in accordance with fire protection class A2 or B1, free from toxic additives, and universally applicable. After its service life, it can be recycled or composted.

1. A method for producing fire-resistant building elements from one or more of renewable raw materials and/or recovered residual materials and/or recyclable biopolymers, a binder, and water, wherein the renewable raw materials comprise at least one selected from the group consisting of cereal, rapeseed, flax, hemp, or rice straw, or algae, hops, maize, or paludiculture plants, and wherein the binder comprises a mixture of magnesium carbonate, magnesium oxide, and magnesium chloride, the method comprising the steps of:
a) introducing the binder and water into a temperature-controllable container;
b) tempering the binder-water mixture within a first defined temperature range;
c) mixing the binder water mixture while maintaining the first defined temperature range;
d) maintaining the first defined temperature range for a first defined period;
e) tempering the binder-water mixture within a second defined temperature range;
f) adding shredded renewable raw materials while maintaining the second defined temperature range;
g) mixing the binder-water-raw material mixture while maintaining the second defined temperature range;
h) maintaining the second defined temperature range for a second defined period;
i) discharging the binder-water-raw material mixture into a dimensionally stable mold; and
j) cooling and curing the binder-water-raw material mixture.

2. The method according to claim 1, characterized in that the discharge of the binder-water-raw material mixture occurs continuously onto a conveyor line.

3. The method according to claim 1, characterized in that the rapidly renewable agricultural raw materials are entirely or partially replaced by crushed building elements and/or fractionated building elements produced according to claim 1.

4. The method according to claim 1, characterized in that process steps (a) to (j) are repeated using different mixture compositions and/or process parameters so that the building elements have two or more layers of different types.

5. The method according to claim 1, characterized in that the process steps of tempering, mixing, and holding are computer controlled and automated.

6. The method according to claim 1, characterized in that the first defined temperature range lies between 25 and 60 degrees Celsius.

7. The method according to claim 1, characterized in that the first and second defined temperature ranges are identical.

8. The method according to claim 1, characterized in that the first and second defined periods last only a few seconds.

9. A building element produced according to the method of claim 1, characterized in that the building element comprises at least one renewable raw material selected from the group consisting of cereal, rapeseed, flax, hemp, or rice straw, or algae, hops, maize, or paludiculture plants and/or crushed and/or fractionated building elements produced according to claim 1, and/or recovered residual materials, and/or recyclable biopolymers, and a binder consisting of magnesium carbonate, magnesium oxide, and magnesium chloride, as well as water, wherein the building element is water-resistant, diffusion-open, flame-retardant, and free from environmentally harmful additives.

10. A building element according to claim 9, characterized in that the raw material content of the building element is between 55 and 80 percent.

11. A building element according to claim 9, characterized in that the building element is a panel.
